(19) United States
(12) Patent Application Publication
(10) Pub. No.: US 2015/0326022 A1
(43) Pub. Date: Nov. 12, 2015

(54) Method and System for Breaker-Less Medium Voltage DC Architecture

(71) Applicant: Huntington Ingalls, Inc., Newport News, VA (US)

(72) Inventors: Thomas A. Baragona, Norfolk, VA (US); Paul E. Jordan, Surry, VA (US); Bruce A. Shiffler, Smithfield, VA (US)

(21) Appl. No.: 14/638,538

(22) Filed: Mar. 4, 2015

Related U.S. Application Data
(60) Provisional application No. 61/948,062, filed on Mar. 5, 2014.

(51) Int. Cl. H02J 4/00

(52) U.S. Cl. CPC H02J 4/00

(57) ABSTRACT

An exemplary breaker-less, medium voltage DC distribution system capable of meeting the demanding operational and performance requirements of, for example, a Navy combatant, is disclosed. Survivability is maximized in the disclosed architecture by providing multiple, individually-controlled power feeds from each “islanded” turbine generator. The system takes advantage of the rapid response of power electronics for fault protection without the penalty of having to shut down major segments of the electrical system to isolate a fault. The use of a multiphase generator configuration with multiple rectifiers (PCM4s) provides for system redundancy and provides better fault tolerance, since the greater the number of rectifier modules used, the less impact a rectifier or bus fault will have on system performance.

### CROSS-REFERENCE TO RELATED APPLICATIONS

This application claims priority to U.S. Provisional Application No. 61/948,062 filed Mar. 5, 2014 (Attorney Docket Number 21323.000521), the content of which is incorporated herein by reference in its entirety.

### STATEMENT REGARDING FEDERALLY SPONSORED RESEARCH OR DEVELOPMENT

This invention was made with government support under Contract Number N65540-09-D-0029 S11200805E awarded by the Naval Surface Warfare Center, Carderock Division & Office of Naval Research. The government has certain rights in the invention.

### BACKGROUND

Based on the Naval Power Systems Technology Development Roadmap (TDR), future Navy power systems will require Medium Voltage DC (“MVDC”) distribution. See “Naval Power Systems (NPS) Technology Development Roadmap,” PMS 320, Apr. 29, 2013, (incorporated herein by reference in its entirety). The Technology Development Roadmap explains that additional technologies are needed for affordable medium voltage DC systems, including new standardized fault detection, localization, and isolation techniques that can operate with power electronics sources and loads; refined techniques for power sharing among sources; refined grounding methods; power controls systems that interface with machinery control systems; and development of scalable, open architecture, medium voltage to low voltage power conversion. As used herein, the term “medium voltage” means 4-69 kV AC (see e.g., IEEE Std. 141) or 1-35 kV DC (see, e.g., IEEE Std. 1709. Because the total electric load onboard ships has grown substantially over the past three decades, medium voltage equipment is necessary to support emerging power needs in naval power systems. Circuit isolation and fault interruption technology must keep up with the increasing power loads on ships.

Conventionally, breakers have been used for circuit isolation and fault interruption. In AC systems, vacuum circuit breakers (VCBs), fused vacuum contactors, and fused disconnects are used for such purposes. However, VCBs are not directly applicable to DC systems because VCBs rely on the zero crossing of the alternating current waveform. The difficulty of interrupting DC Fault current as compared to AC fault current is due to the difference in the way the two systems react to a fault. AC fault current is limited by the circuit's impedance, not just its resistance. AC system fault current frequently crosses zero during fault conditions, which allows the arc to be extinguished thereby interrupting the flow of current during a fault. DC system fault current rises to a higher value since it is limited only by the resistance of the circuit and does not cross a zero current during operation like AC systems. The DC fault current rate of rise is dependent on the system time constant L/R.

Shipboard integrated power systems have high available power and short transmission lengths which can generate high levels of current during a fault. Many critical shipboard electrical loads can be damaged by voltage sags that can be caused if the protection system is slow to isolate the fault. Fast protection for these sensitive loads is required in order to minimize damage to the equipment.

Conventionally, fault isolation in DC systems is typically accomplished using large air circuit breakers or employing an upstream AC circuit breaker in combination with a power converter. Mechanical circuit breakers, however, take several milliseconds to interrupt current, depending on the separation speed of the contacts. And use of electromechanical air circuit breakers may cause voltage distortions and sags that are unacceptable for some sensitive loads.

In DC systems, no natural current zero-crossing exists. While arcs can be interrupted at relatively low voltages, it is difficult to do so at kilovolt levels. A major challenge to the use of shipboard medium voltage DC distribution systems is protection against medium voltage DC bus faults. Medium voltage DC shipboard distribution systems are expected to be rated at ≧6 kV, but commercially available electromechanical circuit breakers are not suitable for medium voltage DC systems above 3 kV. This has prompted the inventors to research and develop solid-state or hybrid breakers for medium voltage DC systems.

The Technology Development Roadmap notes that DC air circuit breakers will continue evolutionary developments. Additional solutions being investigated and developed for DC circuit isolation include building protection concepts into power converters, solid state and hybrid circuit protection, and other advanced DC breaker technologies. However, voltage demands will likely only increase with the introduction into future warships of advanced weapons systems, such as high power radars, rail guns, and lasers, and corresponding changes in power system architectures will make electromechanical circuit breakers even less suitable for medium voltage DC systems.

### BRIEF DESCRIPTION OF THE DRAWINGS

FIG. 1 depicts an electric distribution system architecture, according to an exemplary embodiment.

FIG. 2 depicts a portion of the exemplary electric distribution system architecture, according to an exemplary embodiment.

FIG. 3 depicts another portion of the exemplary electric distribution system architecture, according to an exemplary embodiment.

FIG. 4 depicts another portion of the exemplary electric distribution system architecture, according to an exemplary embodiment.

FIG. 5 depicts another portion of the exemplary electric distribution system architecture, according to an exemplary embodiment.

FIG. 6 depicts yet another portion of the exemplary electric distribution system architecture, according to an exemplary embodiment.

FIG. 7 depicts an exemplary power generation module topology, according to an exemplary embodiment.

### DETAILED DESCRIPTION OF THE INVENTION

Exemplary embodiments of the present invention utilize power electronic devices instead of conventional circuit breakers in a medium voltage DC architecture. One advantage of the disclosed embodiments of the medium voltage DC architecture is that it enables faster protection system response and reduces fault currents due to the speed of power electronic devices versus electromechanical breakers. An architecture that includes electromechanical circuit breakers could compromise this advantage.

The disclosed medium voltage DC architecture also overcomes potential risks, viz., the risk of reduction of redundancy and survivability, by using bulk rectification at each AC generator, e.g., the power generation modules or PGMs. Navy ships predominantly use AC generators to generate and distribute voltage at 450 VAC and a frequency of 60 Hz. Higher voltages result in lower currents to deliver the same amount of power. The majority of loads on a ship are directly powered at 60 Hz, similar to the commercial standard frequency in the United States. Some loads are powered by AC while others require DC power, such as computers and various combat systems. Accordingly, conversion from the distribution input to the specific load DC voltage is required. Technologies such as computers and weapons systems are very intolerant to transients (momentary variations in current, voltage, or frequency) and power interruptions. System reboots caused by brief power interruptions are inconvenient commercially, but are unacceptable in a combat situation. Embodiments of the present invention keep necessary loads powered through faults or transients and quickly isolate electrical faults.

General categories of power electronics-based conversion may be used, for example, onboard a ship, and may involve conversion from or to AC/DC (rectifier), DC/DC (converter), DC/AC (inverter), and AC/AC (transformer or cycloconverter), and more than one phase of power conversion may be used. Short of developing a true DC generator, rectification at the output of an AC generator is the only realistic method of developing medium voltage DC shipboard power. However, isolation of a fault downstream of a single, bulk rectifier (AC/DC converter), as in conventional systems, may require at least temporarily shutting down all loads supplied by the rectifier. In an exemplary four turbine-generator (TG) case that uses a single rectifier for each turbine-generator, that would result in 25% of all electric power loads temporarily shutting down. From an operational standpoint, either commercially or militarily, that would not be acceptable.

The exemplary medium voltage DC architecture disclosed herein employs an alternative strategy in which medium voltage DC breakers are not used, instead relying on the much faster, inherent protection capability of power converters for fault protection. The exemplary breaker-less medium voltage DC architecture disclosed herein uses solid-state switches, such as silicon controlled rectifiers (SCRs) or thyristors, in the power converters (power conversion modules or PCMs, such as the PCM4s) to protect the medium voltage DC buses. If a fault occurs on a medium voltage DC bus, whether for ship service or propulsion, the fault is isolated by inhibiting the firing pulses to the SCRs. More specifically, the exemplary breaker-less medium voltage DC architecture disclosed herein uses multi-phase generators, each with multiple, three-phase sets of outputs, each feeding a phase controlled rectifier, to power ship service and mission loads using a redundant zonal distribution system. Thus, the system provides multiple, individually controlled sources of power to particular loads so that shutdown of any rectifier following a fault only minimally reduces total available power while providing continuity of power to essential loads.

The exemplary breaker-less medium voltage DC architecture may be deployed on a naval warship, such as a surface combatant or an aircraft carrier, or may be deployed in a commercial setting or transportation venue, such as to power one or more commercial buildings, a textile mill, a paper mill, or a subway system, for example. Exemplary loads on a warship powered by the disclosed architecture may include, for example, weapons, including a laser and rail gun; sensors, including air/missile defense radars (AMDRs); propulsion systems, including propellers, pumps and fans; an electromagnetic aircraft launch systems (EMALS); communication systems; heating and lighting systems; computers and electronics; and other systems typically onboard a ship.

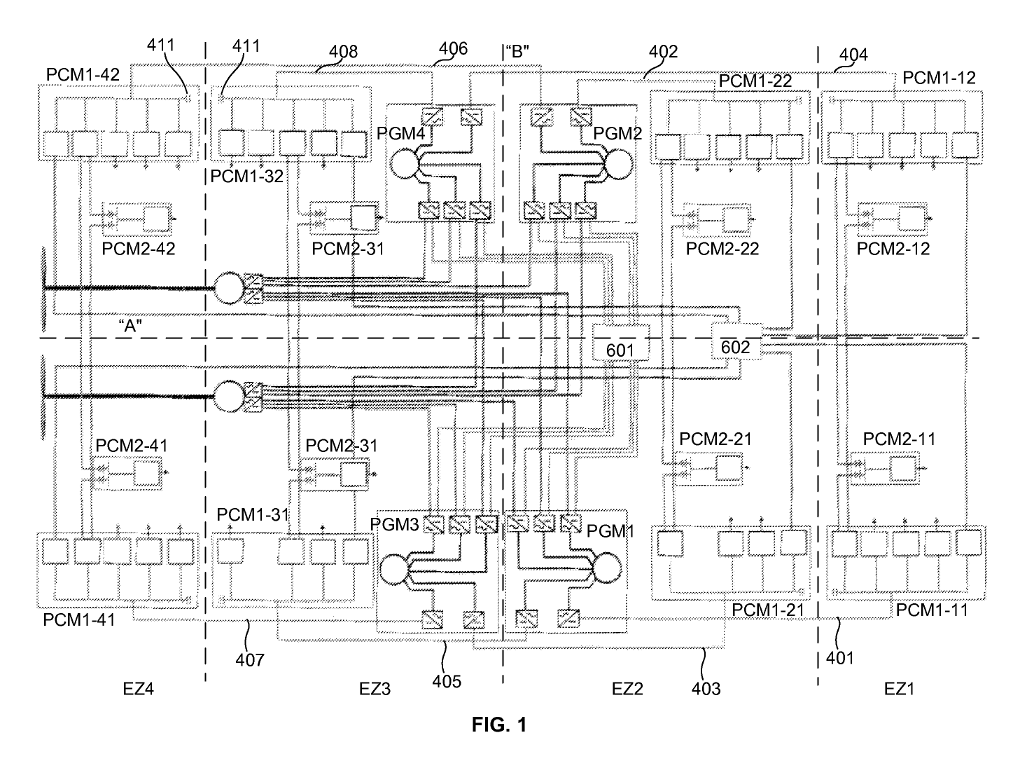

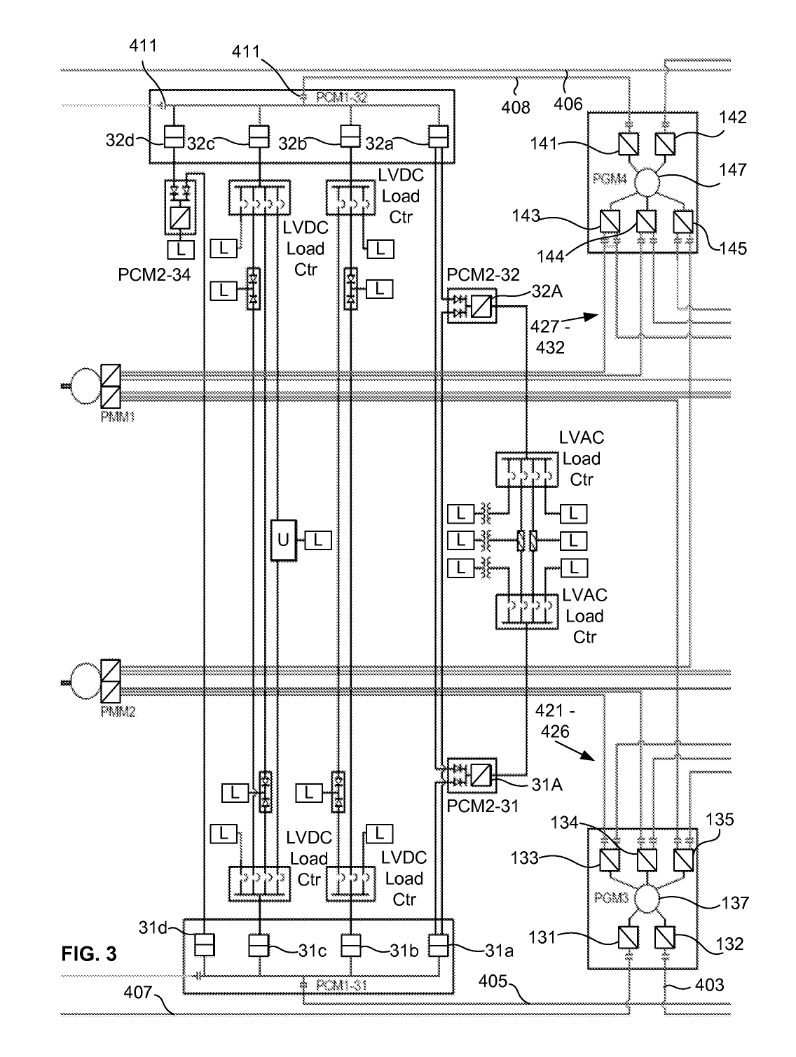

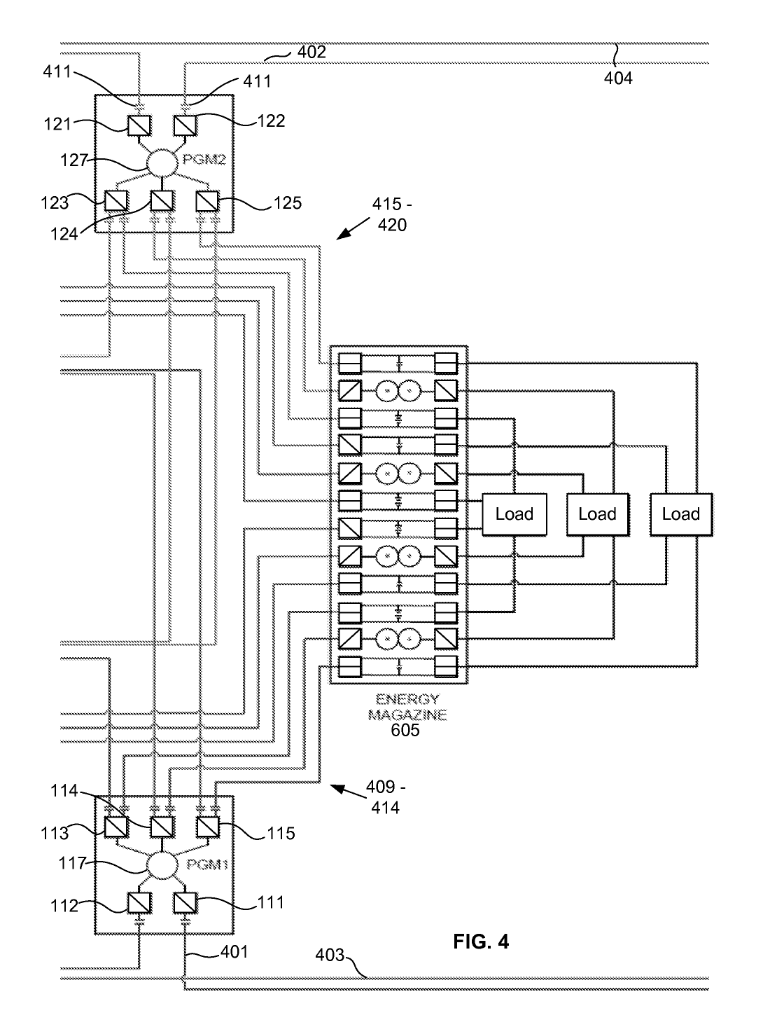

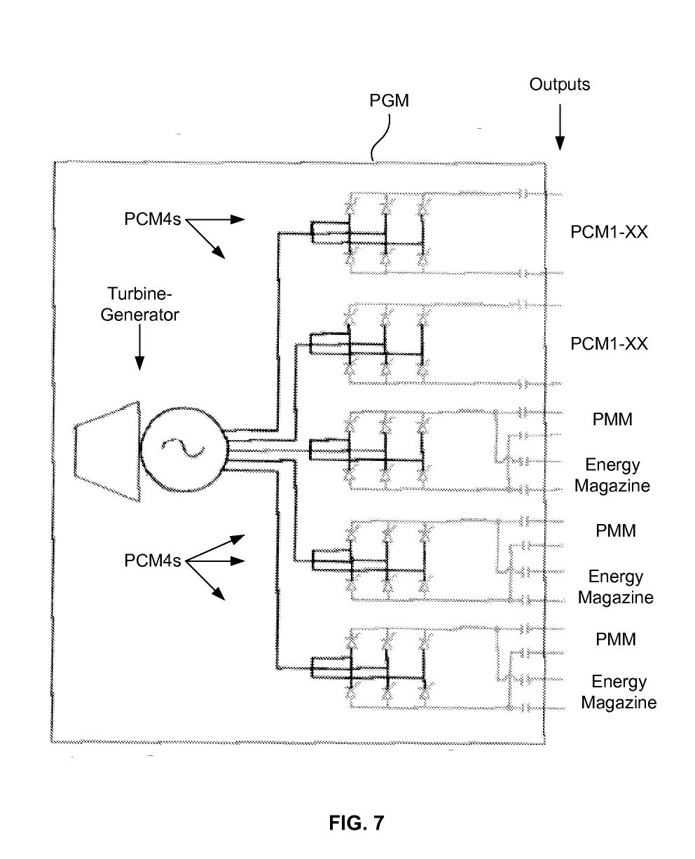

Referring to FIG. 1, a topology of an exemplary breaker-less medium voltage DC architecture is shown. In this exemplary embodiment, there are four power generation modules (PGMs), which are shown in greater detail in FIGS. 3-4. It will be understood by those of skill in the art that the number of PGMs can be scaled up or down based on the power requirements of the platform on which they are installed, A particular exemplary PGM is shown in more detail in FIG. 7. Each power generation module may comprise a multi-phase (e.g., 15 phase) generator, each with five, three-phase sets of outputs, which feed individual phase controlled, six-pulse rectifiers, or PCM4s, as shown in FIG. 7. Thus, each PGM generates AC power using the turbine-generator, converts the AC power to DC power using a plurality of rectifiers (e.g., PCM4s), and each rectifier has outputs to various particular loads and to additional power conversion modules (e.g., PCM1s).

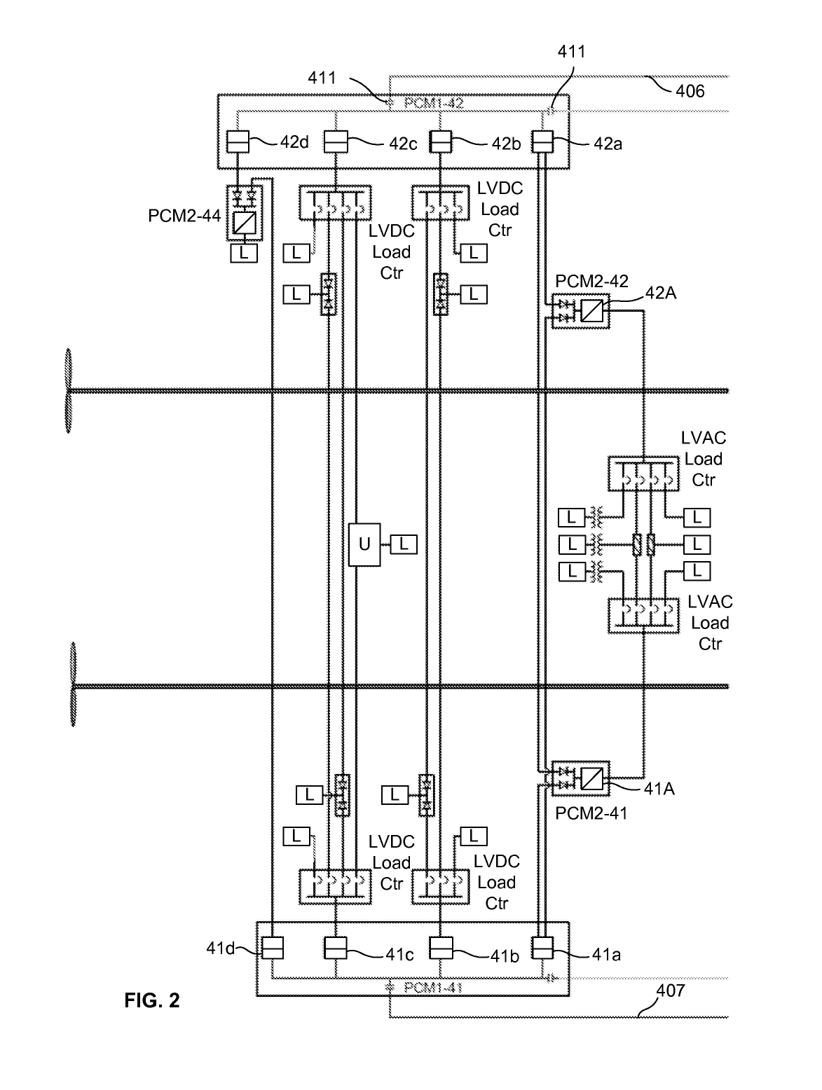

It will be understood that buses downstream of the PCM may be considered low voltage DC buses, or LVDC. The LVDC may have various loads or load centers thereon, as labeled in FIGS. 2-6. While the MVDC buses do not have conventional electro-mechanical circuit breakers, the low voltage system (LVDC) downstream of the PCM1s and PCM2s may use such electro-mechanical circuit breakers.

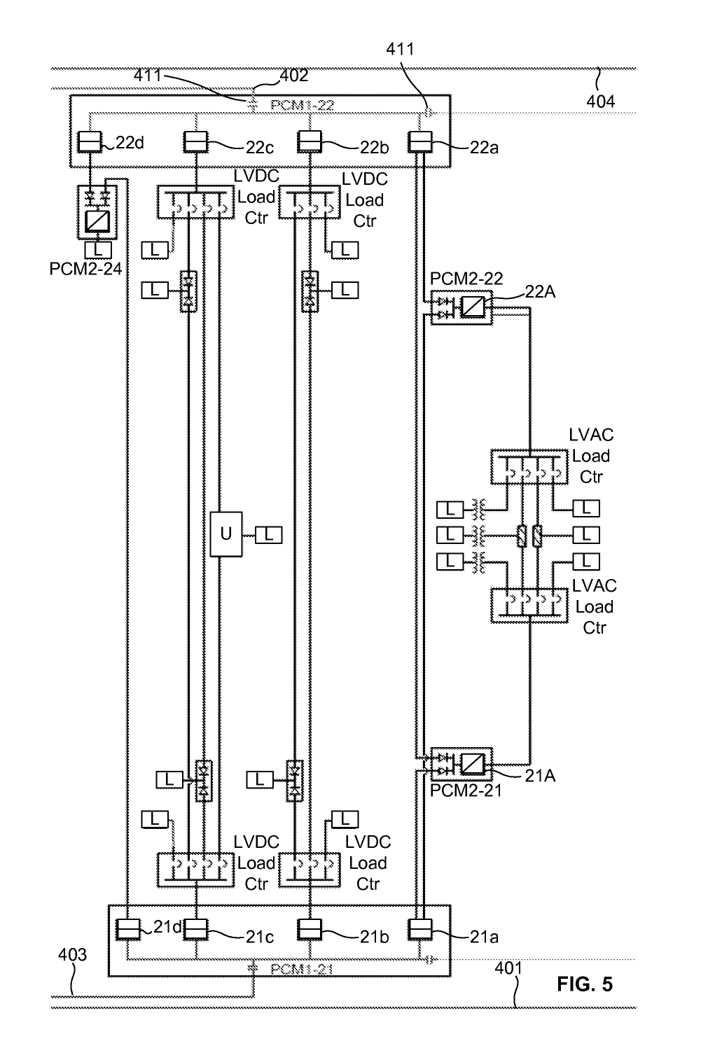

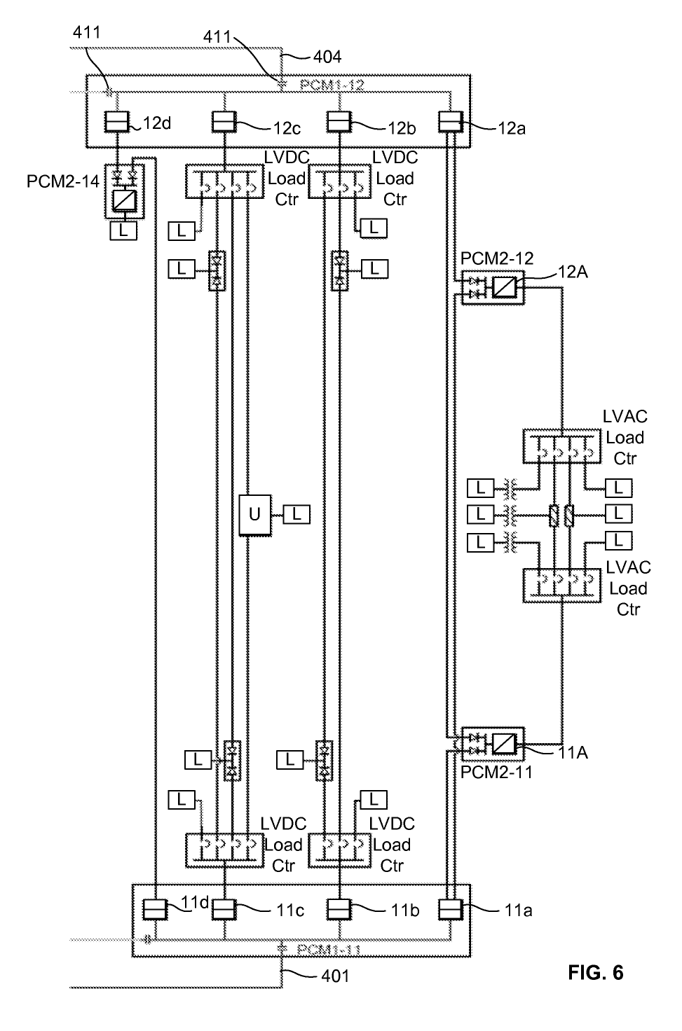

For purposes of clarity, all outputs and/or buses are not shown in FIG. 1. The exemplary design disclosed herein can be scaled up or down depending on the energy requirements of the particular application, e.g., the size of the vessel or setting in which the system is to be used. Further, the energy magazine 605 in FIG. 4 is not shown in FIG. 1 for purposes of clarity. FIGS. 2-6 depict portions of the overall topology shown in FIG. 1, but in greater detail. FIG. 2 represents electrical zone EZ4, or an aft portion of the system. FIG. 3 represents electrical zone EZ3. FIGS. 4-5 represent electrical zone 2. And FIG. 6 represents electrical zone EZ1, or a forward portion of the system. Additional or fewer electrical zones may be used depending on the size of the vessel or setting in which the system is to be used. Boxes with a horizontal line (e.g., 41d in FIG. 2) generally represent a DC/DC converter. Such DC/DC converters generally convert a higher DC voltage to a lower DC voltage, but the reverse may also occur. Boxes with a forward slash therein (e.g., 41A in FIG. 2) generally represent a DC/AC converter. Boxes with a backward slash therein (e.g., 131 in FIG. 3) generally represent an AC/DC rectifier. Various output voltages may be achieved with the converters/inverters/rectifiers. For example, the PCM1s may convert a 3,000V DC input (from the PCM4s, for example) into 800V, 650V, 375V, and/or 300V DC outputs. Similarly, the PCM2s may convert an 800V DC input (from a PCM1, for example) into a 450V AC output, for example.

As shown in FIGS. 2-6, the PCM2s may be powered by the PCM1s and they generally follow the same numbering convention. For example, as shown in FIG. 2, PCM1-41 may power PCM2-42; PCM1-42 may power PCM2-42 and PCM2-44. As shown in FIG. 3, PCM1-31 may power PCM2-31; and PCM1-32 may power PCM2-32 and PCM2-34. As shown in FIG. 5, PCM1-21 may power PCM2-21; and PCM1-22 may power PCM2-22 and PCM2-24. As shown in FIG. 6, PCM1-11 may power PCM2-1 1; and PCM1-12 may power PCM2-12 and PCM2-14. Again, the number of PCM1s, PCM2s, PCM4s, and PGMs is exemplary.

Referring again to FIG. 1, a fault downstream of any of the rectifiers (PCM4s) can be isolated by suspending the gating pulses to the silicon-controlled rectifiers (SCRs) or PCM4s. This may be accomplished using conventional protection circuitry (not shown). Thus, the disclosed system provides twenty, individually controlled sources of power so that shutdown of any rectifier following a fault only minimally reduces total available power. By providing power to ship service loads in each of four electrical zones (e.g., EZ1-EZ4, FIG. 1) from two of these alternate sources, coming from two different and physically separated generators, shutdown of one of these rectifiers may not reduce any of the operational capabilities of the ship. Multiple (e.g., twelve, or three from each PGM) feeds to propulsion motors (PMMs) and to weapon loads assure that these mission critical systems continue to operate at, or near, full power upon one rectifier being shut down. It should be appreciated that the multiple feeds would utilize additional cabling. The disclosed system is capable of reduced power operation with one, two or three generators out of service.

Downstream of the PCM1s and PCM2s on the low voltage buses, fault protection is provided using conventional methods, such as electro-mechanical circuit breakers. The important difference is that in the exemplary multi-phase, multi-rectifier architecture disclosed herein, electro-mechanical circuit breakers are not used on the MVDC portion of the system, and faults are isolated on the MVDC buses by shutting down only small segments of the system, causing little or no loss of service, and the isolated segments need not be restarted until the fault can be corrected. This is advantageous over systems that use a single rectifier downstream of the power generation module (PGM) or turbine-generator (TG), because in such systems large segments of an electric zone or distribution system must be shut down until the fault is located and isolated, and only thereafter can power and function be restored to the remainder of the system.

The exemplary system architecture disclosed herein may use existing components deployed in a novel way. Existing multi-phase electrical machines and gas turbine engines may be used to accomplish the objectives of the present invention. Moreover, the exemplary system architecture employs a conservative approach in that system voltages and currents have been kept at levels consistent with Navy and Industry standards and practices. And system control is kept simple by not operating generators in parallel and by using ht fault detection and control methodology. The inventors also performed physics-based computer simulations to demonstrate the fault isolation capabilities of the system and found that the exemplary system was able to isolate faults more rapidly and in a more particularized manner than conventional electrical distribution systems.

In addition to meeting the objective electrical requirements for various fault protection and operational conditions, the exemplary architecture provides for operational flexibility, survivability, graceful degradation, maintainability, and reduced acquisition and life-cycle/operating cost.

The exemplary system is able to achieve graceful degradation and maintainability by using non-load breaking electro-mechanical switches 411 downstream of power converters which are opened following turn-off of the converter for galvanic isolation for fault isolation or for maintenance. Non-load breaking switches are switches (or “contactors”) that cannot be opened or closed when current is flowing. A non-load breaking switch can carry normal rated design current, but cannot interrupt the flow of normal rated design current or fault current. Thus, the power converter supplying the current must be turned-off so that the switch can opened. In embodiments of the invention, non-load breaking switches may be used for interconnection of electrical zones following loss of two or more generators. The exemplary system can be operated at reduced capability with as few as one generator in operation.

With further reference to FIG. 1, operational flexibility is achieved in the exemplary architecture by employing an exemplary four, turbine generators, each with five, three-phase sets of windings, and requires no circuit breakers on the MVDC buses. The turbine generators are labeled as 117, 127, 137, and 147 (FIGS. 3-4). Each power generation module (PGM) comprises one of the turbine-generators, the corresponding sets of outlets, and power conversion modules or rectifiers (PCM4s). The PGMs are labeled PGM1, PGM2, PGM3, and PGM4 (FIGS. 3-4). Each three-phase set of windings for each of the PGMs supplies a rectifier (PGM4) which may be shut down to isolate a downstream fault. In other words, in the exemplary embodiment each PGM has five PCM4s, which are labeled 111, 112, 113, 114, and 115 for PGM1; 121, 122, 123, 124, and 125 for PGM2; 131, 132, 133, 134, and 135 for PGM3; 141, 142, 143, 144, and 145 for PGM4 (see FIGS. 3-4). In effect, this configuration provides twenty individual power sources which may be controlled separately.

Survivability is maximized in the disclosed architecture by providing multiple, individually controlled power feeds from each “islanded” turbine generator or PGM. In the exemplary embodiment, the turbine-generators are not operated in parallel. As shown in FIG. 1, there are, for example, four electrical zones on the ship, EZ1, EZ2, EZ3, and EZ4. The number of electrical zones, PCM1s, PCM2s, PGMs, and PCM4s may vary depending on the size of the vessel in which the system is to be used. Ship service loads (e.g., on the LVDC side powered by the PCM1s and on the LVAC side powered by the PCM2s) in each zone are supplied by two turbine generators located diagonally opposite each other in the ship for maximum separation and survivability. For example, PCM1-11 is supplied by PGM1 (via bus 401), and PCM1-12 is supplied by PGM4 (via bus 404), and PGM1 and PGM4 are located diagonally opposite of each other. More specifically, PGM1 and PGM4 are located on opposite sides of longitudinal line “A” and vertical line “B,” shown in FIG. 1. Longitudinal line A may be said to go down the middle of a structure, such as a ship, in a longitudinal direction from a forward side to an aft side (near label “A” in FIG. 1). Vertical line B may be said to traverse the middle of a structure, such as a ship, from a port side (near label “B” in FIG. 1) to a starboard side. PCM1-12 and PCM1-11 may supply redundant electrical supply to one or more various loads on the ship. Loads (labeled “L” in the Figures) are allocated to each turbine generator such that, on loss of one turbine generator and transfer of its vital loads, the turbine generator to which the loads transfer will not be overloaded. On loss of more than one turbine generator, contactors between the PCM1s in zones EZ1 & EZ2 and between zones EZ3 & EZ4 may be closed to allow one turbine generator/PGM to supply three, or all four, electrical zones from its respective side of the ship. Power is supplied to each of the propulsion motors (PMM1 and PMM2) and mission loads 601, 602 from each of the turbine generators 117, 127, 137, 147. Mission load 601 may represent various weapons systems onboard a ship, and weapons load 602 may represent various radar systems onboard a ship.

With the propulsion motors (PMM1 and PMM2) and mission loads 601, 602 each supplied by all four turbine generators in the exemplary embodiment, the four, equal-size turbine generator configuration provides graceful degradation by maintaining at least 75% power to those loads on loss of any one turbine generator. Ship service loads (e.g., “L” supplied by the PCM1s and PCM2s) are automatically transferred upon loss of a turbine generator to the turbine generator supplying those loads from the opposite side of the ship. Loads may be transferred using uninterruptible power supplies, auctioneering diodes, automatic bus transfer (ABT) switch, or any other means known in the art.

The solid state switches used in power converters in embodiments of the invention may be SCRs, IGBTs, SiCs or other suitable switches. In particular embodiments, thyristors may be used. Thyristors are generally classified as either converter grade or inverter grade. Inverter-grade thyristors may be used in forced commutation applications such as DC/AC inverters, where faster turn-off is required. Converter-grade thyristors have turn-off measured in tens of milliseconds (slower than inverter-grade thyristors) and are generally used in natural commutation (or phase-controlled) applications. Inverter-grade thyristors may be turned off by forcing current to zero using an external commutation circuit. Both converter-grade and inverter-grade have faster turn-off than circuit breakers, so either converter-grade or inverter-grade thyristors may be used in the disclosed system.

Although a primary objective is to rely on the high-speed turn off capability of power electronic devices for system protection, galvanic isolation is still required following turn off, not only as part of the system protection function, but also for maintenance. In the exemplary embodiment, non-load breaking switches 411 are provided downstream from each PCM4 for galvanic isolation following its shutdown for fault isolation.

The exemplary breaker-less architecture is based on four large, equally-sized turbine generators. Historically, the turbine generators are the most expensive component on a non-nuclear ship, so anything which influences their size and selection is of critical importance. While the turbine generators are not required to be the same size, the commonality of this exemplary four-of-a-kind turbine generator configuration minimizes acquisition cost, based on a bulk-quantity purchase, as well as the associated engineering and installation costs. Lifecycle logistic costs are also reduced based on common replacement parts and training requirements. The high cost of circuit breakers is also avoided, which is normally a significant factor in system acquisition cost. Circuit breakers need not be used on the MVDC system because that MVDC buses are protected by the PCM4s. Any number of turbine-generators may be used. Using four large, fixed speed turbine-generator sets in the exemplary architecture, reduced efficiency during low power demand may occur. However, this can be mitigated by using adjustable speed turbine generator sets, which maximize efficiency as power demand from shipboard electric loads change.

Although it would result in some loss of redundancy of supply, the exemplary architecture may be operated with one or more turbine-generators off-line, including operation with only one turbine generator while at anchor.

As discussed above, the disclosed medium voltage DC electric plant architecture is breaker-less. Medium voltage DC faults are isolated by suspending the firing pulses to the upstream phase controlled rectifier (PCM4s). As referred to above, in the exemplary embodiment, there are four PGMs each comprising a generator (117, 127, 137, 147) with five, three-phase sets of windings (15 phases) and five phase controlled rectifiers (PCM4s or 111-115, 121-125, 131-135, and 141-145). By way of example, a 30 MW generator could comprise five 6 MW rectifiers. The generators are operated as “islanded” sources without the need for parallel generator operation. The phase controlled rectifiers convert the generator output into medium voltage DC for use by the Propulsion Motor Modules (PMM1, PMM2), ship service power converter modules (the ship service converter modules or SSCMs located in the PCM1s) and combat system loads 601, 602.

During normal operation of the exemplary architecture, four PGMs in the breaker-less medium voltage DC electric plant deliver power to ship service loads using a zonal electric distribution system. The zonal electric distribution system may use port and starboard longitudinal cable runs to deliver power through the ship's water tight bulkheads. The longitudinal cable runs may be separated by the maximum deck and athwart ship distance to provide optimum survivability of the system. There are eight longitudinal cable runs, four forward (right side of line “B” in FIG. 1) (buses 401-404) and four aft (left side of line “B” in FIG. 1) (buses 405-408). Each PGM supplies one forward and one aft longitudinal cable run. For example, PGM1 supplies cable runs 401 and 405. Two PGMs are normally used to supply each ship service electrical zone. For example, PGM1 and PGM4 are shown to power ship service electrical zone EZ1 (at PCM1-11 and PCM1-12, respectively). The PGMs used to supply each electrical zone are selected so that the two power sources are as independent as possible. The source for one PCM1 in a given electrical zone comes from a PGM in the forward propulsion plant (e.g., PGM1 or PGM2). The source for the other PCM1 in that given electrical zone comes from the diagonally opposite PGM in the aft propulsion plant (e.g., PGM 3 or PGM4). Loss of a phase-controlled rectifier due to a fault results in the ship service loads in the affected electrical zone transferring to the unaffected side PCM1. The ship service loads supplied by the affected side PCM1 can be re-energized from an adjacent side PCM1, thereby providing redundant power to essential loads. This exemplary arrangement provides the maximum continuity of power to the ship's electrical loads.

In each electrical zone, power to the various DC loads may be supplied through ship service converter modules (SSCMs) located in the PCM1s to supply DC loads at various utilization voltages. DC power supplied by each PGM is converted by the SSCMs to the various utilization voltages at the PCM1s. For example, a 3,000 VDC output from PCM4 111 in PGM1 (FIG. 4) is converted to 300 VDC by DC/DC converter 11a, for example (FIG. 6). Each PCM1 has various DC/DC converters, which are represented in the figures with a box having a horizontal line therein (see, e.g., 11a in FIG. 6). As shown, PCM1-11 has DC/DC converters 11a-11d, PCM1-12 has 12a-12d, etc., for each PCM1. Non-essential DC loads may be supplied by the nearest load center to minimize power cable lengths. Essential DC loads may be supplied from port and starboard feeders through auctioneering diodes to provide uninterruptable power in the event of a loss of power from one of the sources.

To supply AC user equipment, DC power supplied from the PCM1s in each electrical zone may be converted through ship service inverter modules (SSIMs) located in the PCM2s (FIGS. 2-3 and 5-6), and transformers may be used to supply AC loads at various utilization voltages. In the exemplary embodiment, there are two PCM2s located in each electrical zone. For example, EZ1 has PCM2-11 and PCM2-12. Each PCM2 in each electrical zone receives power from the port and starboard PCM located in that electrical zone through auctioneering diodes to provide uninterruptable power in the event of a loss of power from one of the sources. Each PCM2 has a DC/AC inverter to invert DC power supplied from the PCM1 to a utilization AC voltage, and these DC/AC inverters are represented in the figures with a box having a forward slash therein. For example, PCM2-11 has a DC/AC inverter 11A that converts DC power from PCM1-11 to 450 VAC. Other PCM2s have DC/AC inverters, labeled 12A, 21A, 22A, 31A, 32A, 41A, and 42A, for example. Non-essential AC loads may be supplied by the nearest load center to minimize power cable lengths. Essential AC loads (e.g., radar systems such as 602) may be supplied with normal and alternate power from AC load centers supplied from the port and starboard PCM2s in that electrical zone through bus transfer devices.

In the exemplary architecture, the propulsion motors modules (PMM1 and PMM2, FIG. 3) are fed directly from twelve, phase controlled rectifiers (PCM4s) in the PGMs. The propulsion motors are supplied through propulsion motor modules (PMM1 and PMM2). As shown in FIG. 4, pulse power loads (PPLs) (or “Load” in FIG. 4) may be supplied from an energy magazine 605 that comprises energy storage modules and power converters, as explained in further detail below. The energy magazine 605 may supply pulsed-power loads (e.g., loads requiring high energy for a short duration) while the DC loads supplied by the PCM1s are generally continuous DC loads.

Two emergency diesel generator (EDG) sets (not shown) may be included as part of the breaker-less medium voltage DC electric power system. One EDG may be located forward in electrical zone 1 and the other EDG may be located aft in electrical zone 4, for example. The EDGs may be connected to the rectifier modules (PCM4s) of PGM1 and PGM4 and emergency power panels. The diesel generator sets may be used to start the gas turbine generators and supply select essential loads during plant start-up.

Forward and aft shore power connections (not shown) may be made to the rectifier modules (PCM4s) of PGM2 and PGM3, respectively. The shore power connections can be used to energize the ship's electrical system when the ship is dockside.

In the exemplary architecture, the loss of PGM1 results in loss of power to PCM1-11 and PCM1-31. Essential DC loads supplied through auctioneering diodes in electrical zones 1 and 3 and non-transferrable essential DC loads on the unaffected PCM1 are supplied from PCM1-12 and PCM1-32, respectively. In the present scenario (loss of PGM1), PCM1-12 and PCM1-32 supply the entire essential load of both PCM2s in zones 1 and 3; PGM2 non-essential load is shed. Because of the loss of PGM1 in this scenario, three of the feeders supplying propulsion loads (PMM1/PMM2) and the energy magazine 601 are de-energized resulting in 25% loss of available power to these loads; however, the ship's endurance speed can be achieved with the remaining three PGMs. Sufficient discretionary power is available from the remaining three PGMs to supply additional propulsion or pulse power loads.

Further, the loss of two diagonally opposite PGMs results in the momentary loss of power to zones EZ1 and EZ 3 or EZ 2 and EZ 4. Non-load breaking disconnect switches located in the same side forward (PCM1-11, PCM1-21 or PCM1-12, PCM1-22) and aft (PCM1-31, PCM1-41 or PCM1-32, PCM1-42) PCM1s are closed to re-energize the affected zones. Loss of two PGMs on the same side (port or starboard) or in the same propulsion plant (forward or aft) results in similar realignment of ship service loads as described for the loss of one PGM. Six of the feeders supplying propulsion loads and energy magazine are de-energized resulting in 50% loss of available power to these loads. However, the ship's endurance speed can be achieved with the remaining two PGMs. Sufficient discretionary power is available from the remaining two PGMs to supply additional propulsion or weapons loads.

The exemplary breaker-less medium voltage DC electric plant provides improved operability, reliability, and survivability features. Additionally, graceful degradation of the system is enhanced by the multi-phase generator, muti-rectifer PGM topology, which provides twenty independent sources of power. This allows the system to continue to supply power to ship service, sensor, weapons and propulsion loads even in degraded modes of operation. The exemplary PGM multi-phase generator, multi-rectifier design enhances the system fault tolerance by producing only one-fifth of the fault current (compared to a single converter in the PGM) and allows the branches to remain shut down after a fault, with only minimal, or no, loss of capability. With particular regard to the power generation modules, each PGM may comprise a gas turbine engine coupled to a synchronous generator. To avoid cost associated with the development of a new prime mover design, existing gas turbines may be used in the exemplary architecture.

One of the main benefits of a medium voltage DC distribution system is that the frequency of the prime mover is decoupled from the medium voltage DC bus. Since the generator is not directly connected to a fixed-frequency (60 Hz) distribution system, it is not constrained to operate at a constant speed. Instead, power conversion modules (PCM4s) in the PGM act as the interface between the generator output and the shipboard medium voltage DC distribution system buses. This allows the generator in the PGM to operate at higher than conventional speeds, such as speeds beyond 3600 rpm. Operation of the PGM at higher rotational speeds for the same output power results in smaller torques and, therefore, reduced machine size and weight. Also, by adjusting PGM speed to maximize efficiency as the power demand from shipboard electric loads changes, improvements in fuel efficiency can be realized. Accordingly, variable-speed PGMs capable of high speed operation may beneficially be used in the exemplary system.

As referred to above, the exemplary power generator is a multi-phase design with five, 3-phase sets of windings (15-phases). Each set of three-phase windings is connected to a phase-controlled rectifier (PCM4) for interface to the medium voltage DC buses (e.g., 401-408). Multiphase machines are characterized by a stator winding composed of a generic number of phases. Multi-phase machines offer many benefits as compared to traditional three-phase designs. These benefits include increased fault tolerance, higher power ratings achieved through power segmentation, and enhanced performance in terms of efficiency and torque ripple.

As shown in FIG. 7, in the exemplary system architecture, each PGM includes five (5) phase-controlled rectifiers (PCM4s). Each set of three-phase windings from the PGM is directly connected to one of the five, phase-controlled rectifiers. The phase-controlled rectifiers are each rated to supply the maximum load condition, including losses. Three (3) of the phase-controlled rectifiers provide medium voltage DC outputs for propulsion (PMM) and the energy magazine 605. Two (2) of the PCM4s provide medium voltage DC outputs for ship service loads (PCM1-XX). Each phase-controlled rectifier (PCM4) is provided with non-load breaking switches 411 on the DC output to provide galvanic isolation. The use of a multi-three-phase generator configuration with multiple rectifiers provides for system redundancy and provides better fault tolerance, since the greater the number of rectifier modules used, the less impact a rectifier or bus fault will have on system performance.

One of the main challenges to using DC distribution systems aboard ships is protection against faults on the DC bus. As explained above, the exemplary breaker-less medium voltage DC architecture uses solid-state switches in the phase-controlled rectifiers (PCM4s) to protect the medium voltage DC buses. If a fault occurs on a medium voltage DC bus, whether for ship service or propulsion, the fault is isolated by inhibiting the firing pulses to the SCRs.

Using a PGM with a multi-phase generator, multi-rectifier topology allows the affected medium voltage DC bus to remain de-energized following isolation of a fault by providing redundant sources of power to essential ship service loads in the same zone. Ship service loads (PCM1s) may be supplied by eight independent medium voltage DC buses: four port and four starboard. This results in a more fault tolerant design since the fault current produced is significantly lower compared to a single-rectifier design. Ship service loads in each electrical zone can receive power from two independent rectifiers supplied from diagonally opposite generators.

In the fault protection strategy for the exemplary breaker-less medium voltage DC architecture, when a fault is detected on the medium voltage DC bus, the phase-controlled rectifier controller inhibits firing pulses to the SCRs to interrupt the fault. Non-load breaking electro-mechanical switches are opened after the fault is interrupted to achieve galvanic isolation of the medium voltage DC bus between the affected phase-controlled rectifier (PCM4) and connected PCM1. This results in a simpler operating system for the breaker-less medium voltage DC architecture since there is no need to determine fault location, realign switches, or re-energize the affected medium voltage DC bus. The affected medium voltage DC bus can remain de-energized until the fault is removed and the medium voltage DC bus is ready to be returned to service. Incorporating this circuit breaker functionality into the PCM4s eliminates the need for circuit breakers anywhere on the MVDC bus, thereby allowing reduced space, weight, maintenance and cost.

The Technology Development Roadmap discusses the energy storage (ES) needs for future naval power systems to support advanced weapons and sensors, load leveling, emergency power, generator transient support, and fuel savings initiatives. In particular, it is noted that combining energy storage with the ship's power system into an “Energy Magazine” is desired to reduce the overall energy storage footprint. An energy magazine can accommodate multiple loads by providing appropriate power conversion and energy storage.

An embodiment of the breaker-less medium voltage DC architecture uses an energy magazine 605 that comprises multiple motor-generator (“MG” in FIG. 4) sets for flywheel energy storage. Each flywheel is supplied from a phase-controlled rectifier. The output of each flywheel is rectified using an AC/DC converter (designated with a box having a back slash therein in FIG. 4) to supply mission loads (represented by boxes labeled “Load” in FIG. 4). One or more of the “Loads” in FIG. 4 may represent a weapons system load. In this arrangement the rectifier outputs can be tailored to supply multiple mission loads with varying power and voltage requirements. The use of multiple flywheels (MG sets) can allow the outputs to be connected in parallel to supply the mission loads, thereby enhancing system redundancy. The number of flywheels (MG sets) can be scaled up or down based on the power requirements of the platform on which they are installed. In addition, the Energy Magazine 605 can be used to support power management, load leveling and emergency power on the ship service system. In alternative embodiments of the invention, the energy magazine could comprise a bank of capacitors for capacitor energy storage or a plurality of batteries for battery energy storage.

In conclusion, the disclosed exemplary architecture provides a breaker-less, medium voltage DC system capable of meeting the demanding operational and performance requirements of, for example, a Navy combatant. The system takes advantage of the rapid response of power electronics for fault protection without the penalty of having to shut down major segments of the electrical system to isolate a fault.

While the foregoing written description of the invention enables one of ordinary skill to make and use the breaker-less, medium voltage DC system, those of ordinary skill in the art will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A medium voltage direct current zonal electric distribution system to deliver power to loads on a structure, the system comprising:
a first power generation module (PGM) having:
a multi-phase turbine-generator with outputs to a first plurality of rectifiers (PCM4s) that convert alternating current (AC) output from the turbine-generator to direct current (DC) to power the loads.

2. The medium voltage DC system of claim 1, wherein the plurality of rectifiers (PCM4s) comprises five rectifiers.

3. The medium voltage DC system of claim 1, further comprising a second PGM having a multi-phase turbine-generator with outputs to a second plurality of rectifiers (PCM4s) that convert alternating current (AC) output from the turbine-generator to direct current (DC) to power the loads.

4. The medium voltage DC system of claim 3, wherein the first and second PGMs are located in diagonally-opposite quadrants on the structure.

5. The medium voltage DC system of claim 3, further comprising a first plurality of power conversion modules (PCM1s) downstream of and electrically connected to the first and second PGMs via cables, each PCM1 comprising a ship service power converter module that converts a DC input voltage to a different DC output voltage.

6. The medium voltage DC system of claim 5, wherein each PCM1 is powered by more than one PGM.

7. The medium voltage DC system of claim 1, wherein upon a power fault at the first or second PGM, the system transfers electrical loads to the second or first PGM, respectively.

8. The medium voltage DC system of claim 5, wherein if a fault occurs on one of the cables, the fault is isolated by inhibiting firing pulses from the turbine generator to a rectifier that powered the cable where the fault occurred.

9. The medium voltage DC system of claim 1, wherein the structure is a ship.

10. The medium voltage DC system of claim 9, wherein the loads comprise at least one of the set consisting of a propulsion system, a weapons system, and a radar system.

11. The medium voltage DC system of claim 10, wherein each PCM4 is a phase-controlled rectifier that converts the AC output into DC for use by the propulsion system and the PCM1s.

12. The medium voltage DC system of claim 5, further comprising a second power conversion module (PCM2) downstream each of the PCM1s.

13. The medium voltage DC system of claim 12, wherein the PCM2s convert a DC input into an AC output.

14. The medium voltage DC system of claim 13, wherein the AC output of the PCM2 powers a radar system.

15. The medium voltage DC system of claim 3, wherein a subset of the first and second plurality of PCM4s power a propulsion system and a weapons system.

16. The medium voltage DC system of claim 15, wherein two PCM4s at each of the first and second PGMs power two PCM1s, respectively, said two PCM4s being different than the subset of the first and second plurality of PCM4s that power the propulsion system and the weapons system.

17. The medium voltage DC system of claim 1, further comprising an energy magazine comprising one of the set consisting of a plurality of motor-generator sets for flywheel energy storage, a plurality of capacitors for capacitor energy storage, and a plurality of batteries for battery energy storage.

18. The medium voltage DC system of claim 17, wherein the energy magazine is supplied from at least one of the PCM4s at each of the first and second PGMs.

19. The medium voltage DC system of claim 18, wherein an output of each motor-generator is rectified using an AC/DC converter to supply a weapons system load.

20. A medium voltage direct current zonal electric distribution system to deliver power to loads on a structure, the system comprising:
a power generation module having a multi-phase turbine-generator with outputs to at least one rectifier (PCM4) that converts alternating current (AC) output from the turbine generator to direct current (DC);
at least two power conversion modules (PCM1s) downstream of the PCM4s, each of the PCM1s being supplied with power from a different PCM4,
wherein an electrical fault that occurs on a bus downstream or upstream of the at least two PCM1s is isolated by inhibiting firing pulses from the turbine generator to a particular PCM4 that powered the bus where the fault occurred.
